(19) United States
(12) Patent Application Publication
(10) Pub. No.: US 2007/0259317 A1
(43) Pub. Date: Nov. 8, 2007

(54) METHOD AND KIT FOR ASSISTING IN THE SELECTION OF AN ADORNMENT

(76) Inventor: Christine Heather REWELL, Carlingford (AU)

Correspondence Address: HOGAN & HARTSON LLP, ONE TABOR CENTER, SUITE 1500, 1200 SEVENTEENTH ST, DENVER, CO, 80202, US

(21) Appl. No.: 11/744,057

(22) Filed: May 3, 2007

(30) Foreign Application Priority Data
May 5, 2006 (AU) 2006902363

(51) Int. Cl. G09B 19/00

(52) U.S. Cl. 434/99

(57) ABSTRACT

A kit for assisting in the selection of an adornment to be worn by a person is provided. The kit includes one or more option charts displaying a number of options of different possible facial and/or head colour characteristics for comparison with the facial and/or head colour characteristics of the person and also includes one or more colour charts displaying a corresponding number of collections of suitable adornment colours. Each collection of suitable adornment colours is associated with a different option on the one or more option charts. The kit further includes a plurality of members, each providing a different possible facial outline shape for comparison with the facial outline shape of the person. Each facial outline shape has an associated collection of suitable adornment shapes. A method for using the kit is also provided.

### RELATED APPLICATION

The present application claims priority of Australia Patent Application No. 2006902363 filed May 5, 2006, which is incorporated herein in its entirety by this reference.

### FIELD OF THE INVENTION

The present invention relates methods and apparatus for use in assisting people in making selections of adornments which suit a particular person.

### BACKGROUND TO THE INVENTION

The process of selecting an adornment can be an overwhelming and time consuming exercise when a person is faced with a wide variety of choices of differing styles and colours. While the final selection of an adornment comes down to personal taste, ideally a person wants reassurance that the final selection will suit the person.

As an illustrative example, consider a person wishing to purchase a new pair of spectacles. Normally a person visits an optician and undergoes an eye examination to determine the person's prescription. Next comes the selection of spectacle frames, whereby the person may be faced with a display of hundreds or thousands of different frames of different shapes, styles and colours.

Typically, the optician or a sales assistant is on hand to offer assistance to the person by making recommendations of different frames to try on. However, such recommendations may be influenced more upon the assistant's taste rather than the person's taste. Furthermore, a purchaser may be concerned that the assistant has more of an interest in making a sale rather than reliably recommending a frame which does suit the person.

Ultimately, the process of selection can become a case of trial and error, requiring the person to try on many different frames. For the purchaser, this can be a tedious and time consuming exercise. For the retailer, this can undesirably take up the time and attention of the assistant away from other customers.

### SUMMARY OF THE INVENTION

It is an object of the present invention to provide a method and a kit which assists in the process of selecting an adornment by narrowing the choice of adornments to those which suit a particular person.

According to a first aspect of the present invention there is provided a method for assisting in the selection of an adornment to be worn by a person, the method comprising the steps of:
providing one or more option charts displaying a plurality of options of different possible facial and/or head colour characteristics, each option having an associated collection of suitable adornment colours for the respective colour characteristics;
selecting an option which has colour characteristics which are the nearest match to the person;
indicating, to the person, the collection of suitable adornment colours associated with the selected option to allow the person to select a suitable colour for the adornment from the indicated collection;
providing a plurality of different possible facial outline shapes, each facial outline shape having an associated collection of suitable adornment shapes;
selecting one of the facial outline shapes which is the nearest match to the facial outline shape of the person;
indicating, to the person, the collection of suitable adornment shapes associated with the selected facial outline shape to allow the person to select a suitable adornment shape from the indicated collection.

According to a second aspect of the present invention there is provided a kit for assisting in the selection of an adornment to be worn by a person, the kit comprising:
one or more option charts displaying a number of options of different possible facial and/or head colour characteristics for comparison with the facial and/or head colour characteristics of the person;
one or more colour charts displaying a corresponding number of collections of suitable adornment colours, each collection of suitable adornment colours being associated with a different option on the one or more option charts; and
a plurality of members, each member providing a different possible facial outline shape for comparison with the facial outline shape of the person, each facial outline shape having an associated collection of suitable adornment shapes.

The present invention advantageously provides a method and tools for speeding up the process of selecting an adornment by producing potential recommendations which are determined to suit a particular person. In preferred embodiments, the method and tools are interactively used with the person which provides the person with more confidence as to the recommendations being made.

### BRIEF DESCRIPTION OF THE DRAWINGS

A preferred embodiment of the present invention will now be described with reference to the accompanying drawings, in which,

FIG. 1 shows a preferred embodiment of an option chart component;

FIG. 2 shows the option chart component of FIG. 1 flipped open to expose a different option chart;

FIG. 3 shows colour chart #1;

FIG. 4 shows colour chart #2;

FIG. 5 shows colour chart #3;

FIG. 6 shows colour chart #4;

FIG. 7 shows colour chart #5;

FIG. 8 shows colour chart #6;

FIG. 9 shows colour chart #7;

FIGS. 10a-10j show different types of facial outline shapes;

FIG. 11 shows a member providing a facial outline shape;

FIG. 12 shows a flip chart of members providing different facial outline shapes; and

FIG. 13 shows the flip chart of FIG. 12 in use.

### DESCRIPTION OF PREFERRED EMBODIMENT

The present invention lends itself to many different implementations and applications, as will be apparent to those skilled in the art. The following is intended to illustrate only one possible implementation.

To assist in the selection of adornments, such as spectacle frames, which suit a particular person, a kit of visual tools is provided. The kit comprises three main components. The first is an option chart component 10, which comprises a series of option charts 12 which display a number of different options 14 of different possible facial and/or head colour characteristics. The second is a colour chart component, which comprises a series of colour charts 20-26 related to the various options on the option charts. The third component is a series of members 30 displaying different possible facial outline shapes 4049.

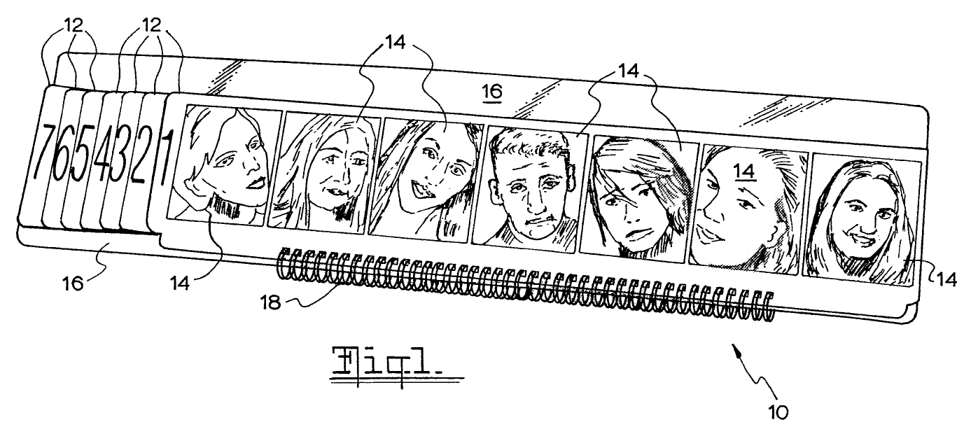

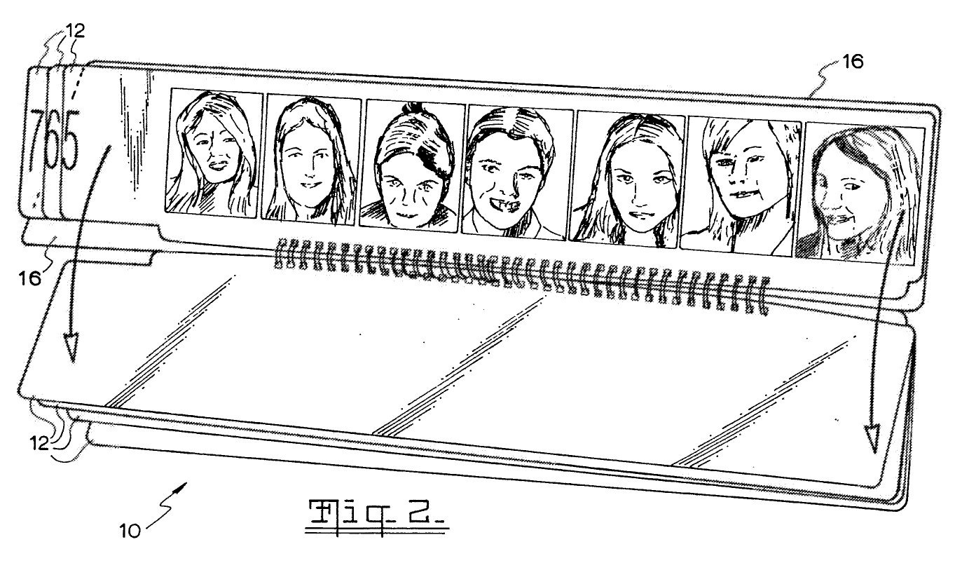

The option chart component 10 is illustrated in FIGS. 1 and 2. A series of seven option charts 12 are provided, ideally in the form of laminated cards. The charts 12 are arranged on a stiff backing card 16 and are bound together by a binder 18 at one edge. The binder 18 allows the charts 12 to be flipped in order to see the face of different charts 12, as shown in FIG. 2. Ideally, as shown, the charts 12 are progressively longer in size, from the top chart to the bottom chart, so that the left hand edge of each chart 12 is visible. On this edge, each chart 12 displays a unique number from 1 to 7 to identify the chart 12.

Each chart 12 displays seven options 14 of different possible facial and/or head colour characteristics. Ideally, these options 14 are displayed in the form of photographs of different models exhibiting the different colour characteristics. The models may be a mix of different sex. It is preferred that each chart 12 shows seven options 14 sharing a general similarity of colour characteristics compared to the other charts. To illustrate, a particular preferred arrangement of options 14 of the charts 12 would be as follows.

Chart #1 has a selection of men and women with blonde hair, fair complexions and light coloured eyes. These 7 photographs are arranged from the coolest overall appearance (blue based pigmentations to the right of the card), to the warmest overall appearance (most golden pigmentations to the left of the card). In the centre are what would be described as Neutral blondes—neither warm nor cool.

Chart #2 has a selection of men and women with dark hair, medium to deeper complexions and darker eye colourings. These 7 photographs are arranged from the coolest overall appearance (blue based pigmentations to the right of the card), to the warmest overall appearance (most golden pigmentations to the left of the card). In the centre are what would be described as Neutral brunettes—neither warm nor cool.

Chart #3 has a selection of men and women with very warm or golden based pigmentations in their hair, complexion and eye tones. These 7 photographs are arranged from the lighter colourings within the group (to the right of the card), to the darker colourings within the group (to the left of the card). In the centre are mid tonings for the group.

Chart #4 has a selection of men and women with very cool or blue based pigmentations in their hair, complexion and eye tones. These 7 photographs are arranged from the lighter colourings within the group (to the right of the card), to the darker colourings within the group (to the left of the card). In the centre are mid tonings for the group.

Chart #5 has a selection of men and women with a subtle or muted appearance to the pigmentation in their hair, complexion and eye tones. They have low contrast between the pigment tones of their hair, complexion and eyes. These 7 photographs are arranged from the coolest overall appearance (blue based pigmentations to the right of the card), to the warmest overall appearance (most golden pigmentation to the left of the card). In the centre are what would be described as Neutral deep blondes—neither too warm nor too cool.

Chart #6 has a selection of men and women with a bright appearance to the pigmentation in their hair, complexion and eye tones. They have reasonably high contrast between the pigment tones of their hair, complexion and eyes. Eyes are brighter or jewel-like. These 7 photographs are arranged from the lighter colourings within the group (to the right of the card), to the darker colourings within the group (to the left of the card).

Chart #7 has a selection of men and women with varying tones of grey. Individuals who in their later years in life have pigmentation which is ‘cooling’. These 7 photographs are arranged from the lighter colourings within the group (to the right of the card), to the darker colourings within the group (to the left of the card).

The charts 12 can be compared against the colour characteristics of a person by holding the charts 12 under the person's chin, for example. The general group characteristics of each chart 12 is initially compared with the person's characteristics to determine which chart generally best matches the colour characteristics of the person. For example, a person with light hair, fair skin and light eyes will have a clear match with chart #1 as a group.

Once a particular chart is matched against the person's general colour characteristics, each photograph or option on the particular chart is compared with the person's colour characteristics to determine which particular option provides the best match. Therefore, if chart #1 provided the best general match, the further determination of which side of chart #1 works best for the person—the the right side of chart #1 (the blue based side) or the left side of the card (the most golden side).

Once a particular option 14 is selected as being the best match with the colour characteristics of the person, the colour chart component comes into use.

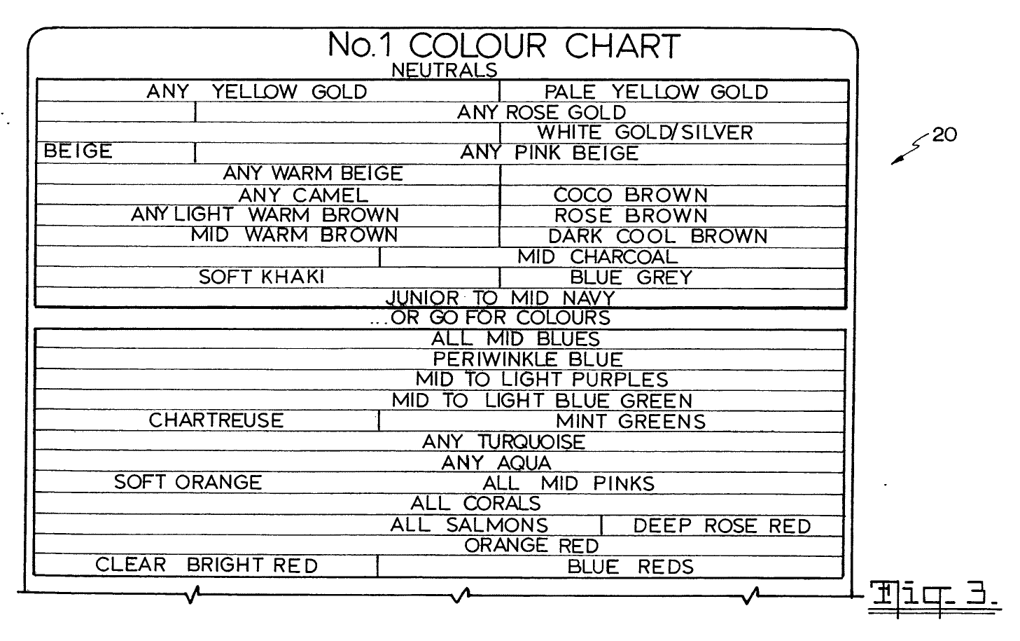

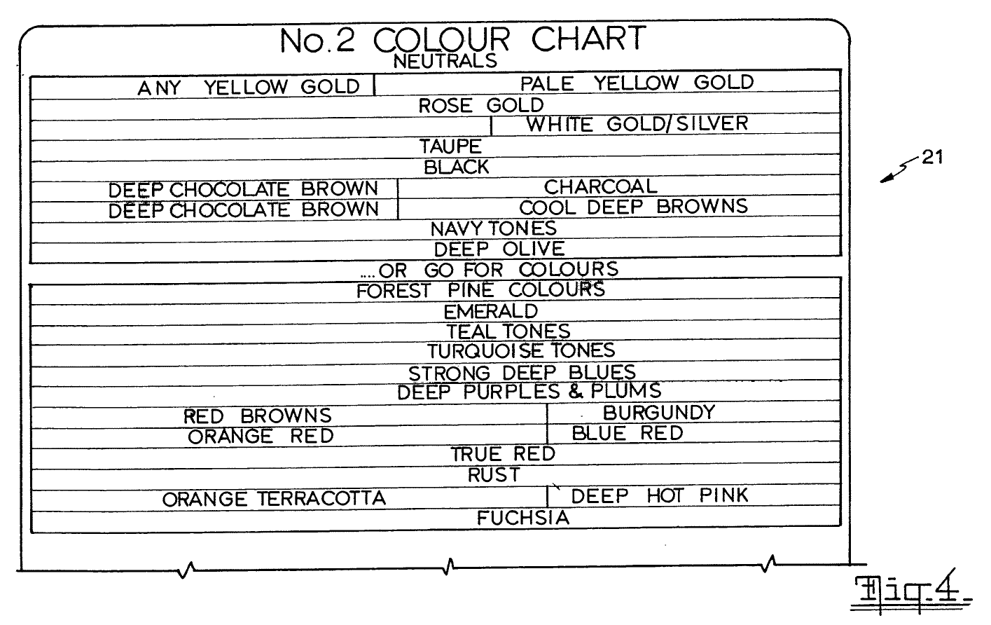

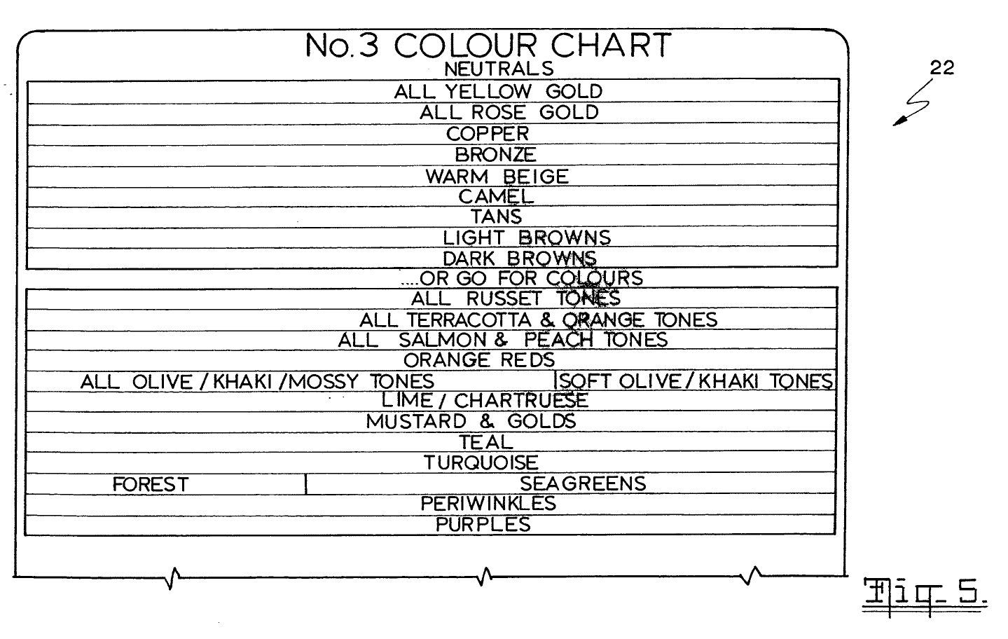

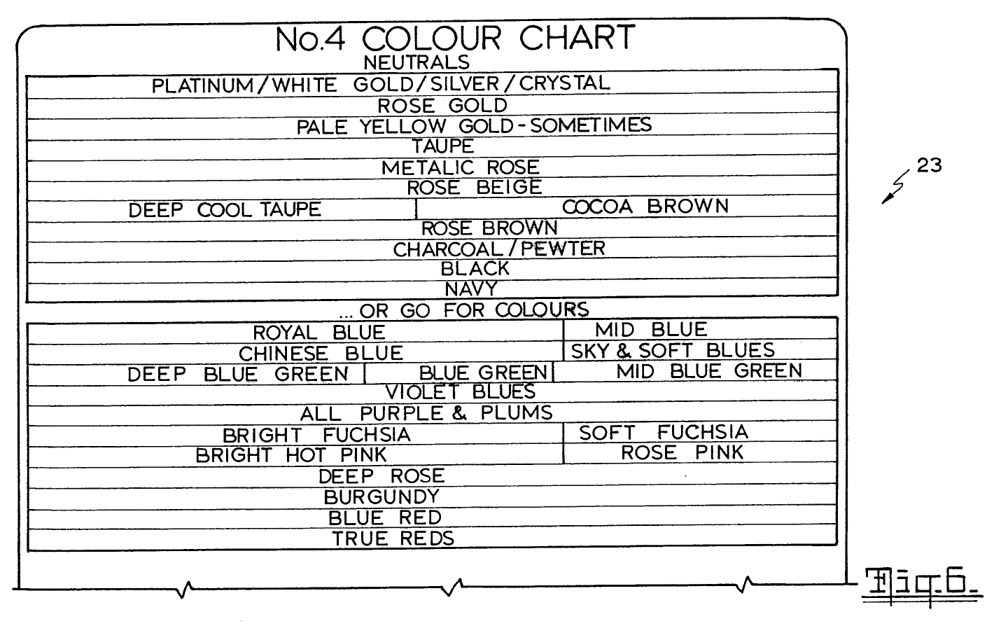

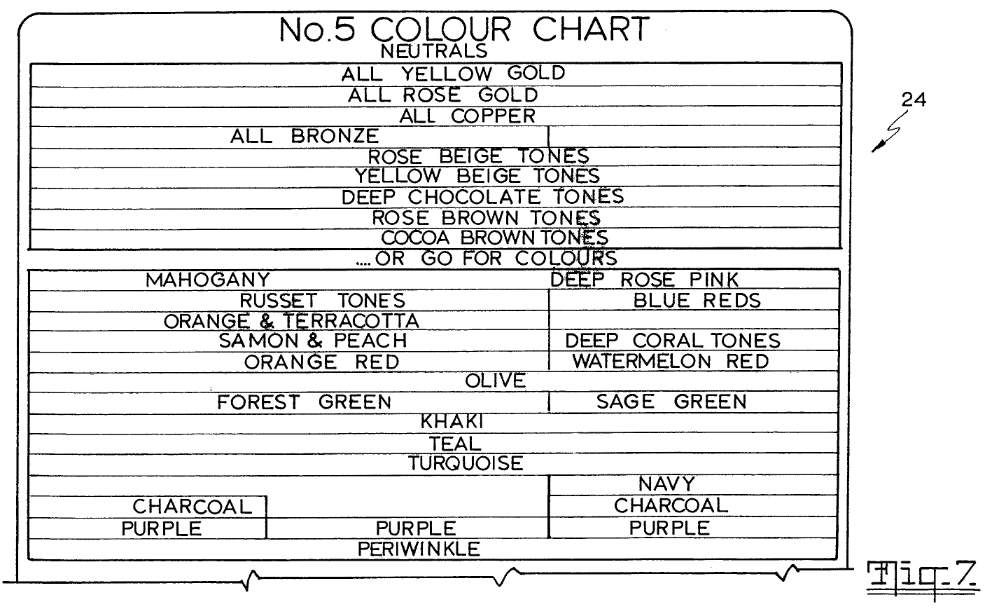

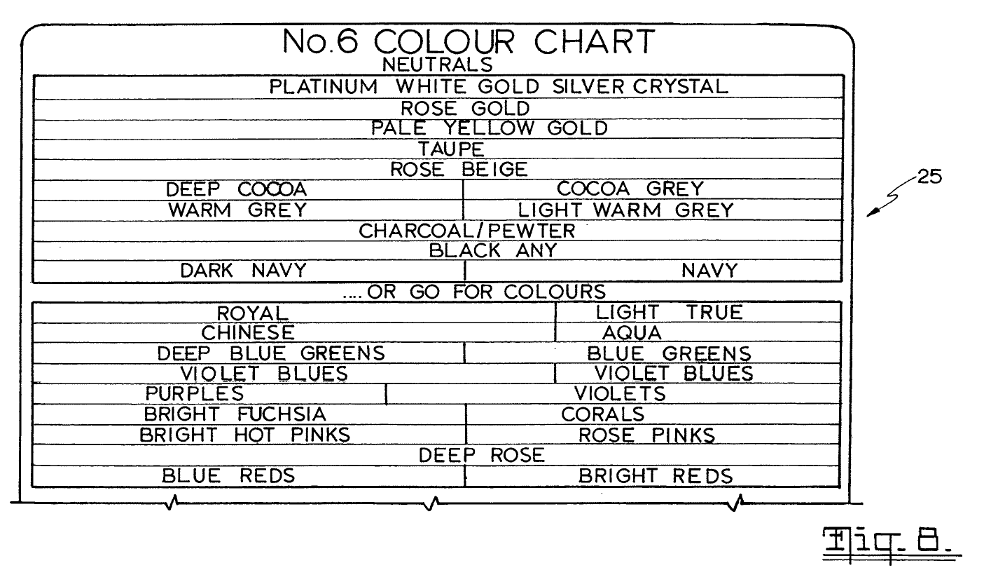

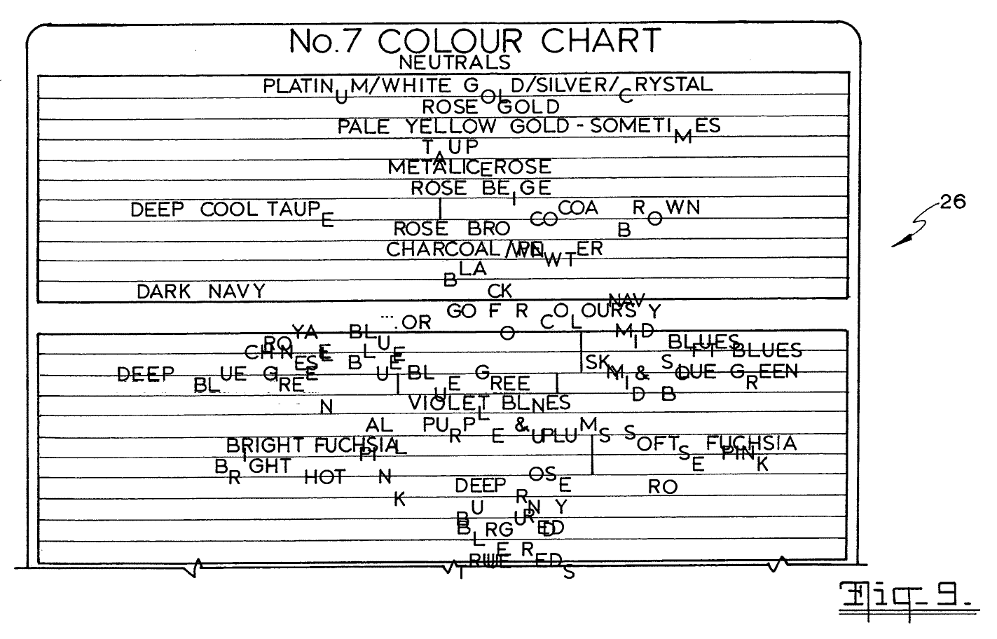

The colour chart component comprises a series of seven colour charts 20-26, ideally in the form of laminated cards. Like the option chart component 10, the colour charts 20-26 can be arranged on a stiff backing card and be bound together by a binder at one edge. The binder allows the colour charts 20-26 to be flipped in order to see the face of different colour charts 20-26. Each colour chart 20-26 has a unique number from 1 to 7, to respectively relate each colour chart to the similarly numbered option chart 12, see FIGS. 3-9. In other words, colour chart #1 works with option chart #1, colour chart #2 works with option chart #2, colour chart #3 works with option chart #3 etc. As shown, the colours on each colour chart are displayed in horizontal strips across the page from left to right like lines of text in a book.

Each colour chart 20-26 is designed, such that, when the colour chart 20-26 is placed below and in alignment with the respective option chart 12, the adornment colours which suit a particular option 14 are set out below the particular option 14. Referring to colour chart #1 in FIG. 3, for example, the colour chart 20 indicates that only options 14 on the left hand side of option chart #1 would suit orange/red spectacle frames, while only options 14 on the right hand side of option chart #1 would suit blue/red spectacle frames. Some colours, for example, Periwinkle Blues are shown to suit all options 14 on option chart #1.

The ‘top to bottom’ colour arrangement of the colours on the colour charts 20-26 are specifically arranged to provide a purpose of suitable colour choice. As shown, the colours at the very top of each of the colour charts 20-26 displays suitable metal frame options, e.g. bright yellow gold (18/22 ct), soft yellow gold (9 ct), rose gold, white gold/silver/platinum, copper, bronze, brass.

The next section indicates the suitable neutral colour frame options, i.e. those colours with the greatest versatility and which do not date quickly. They mix and match easily, the wearer will not tire of them quickly and others will not find them very memorable when they see the person wearing them often.

The bottom section on the colour charts 20-26 is the suitable lively colour frame options, which provide options for people wanting to be more experimental and extroverted with their colour choices and non-verbal messages to the world around them.

The options of suitable colours have now been provided and the next step is to determine suitable frame shapes. In this regard, suitable frame shapes are dictated by the outline shape of a person's face. The third component is a series of members 30 displaying different possible facial outline shapes 40-49 for this purpose.

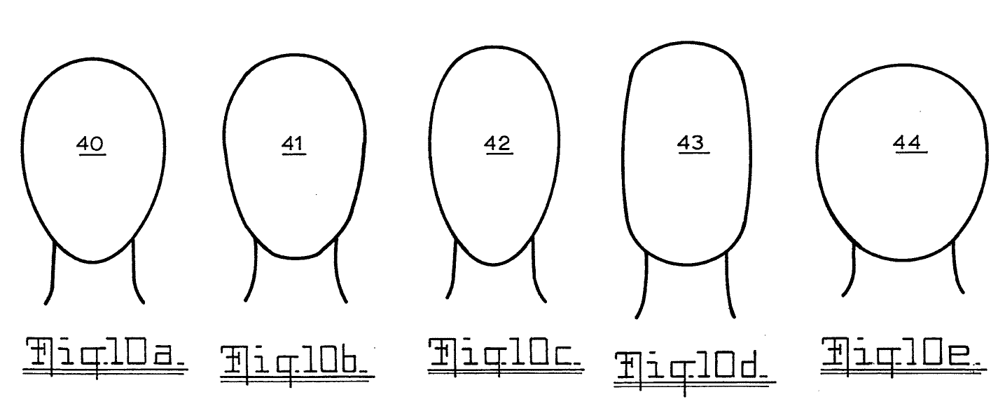

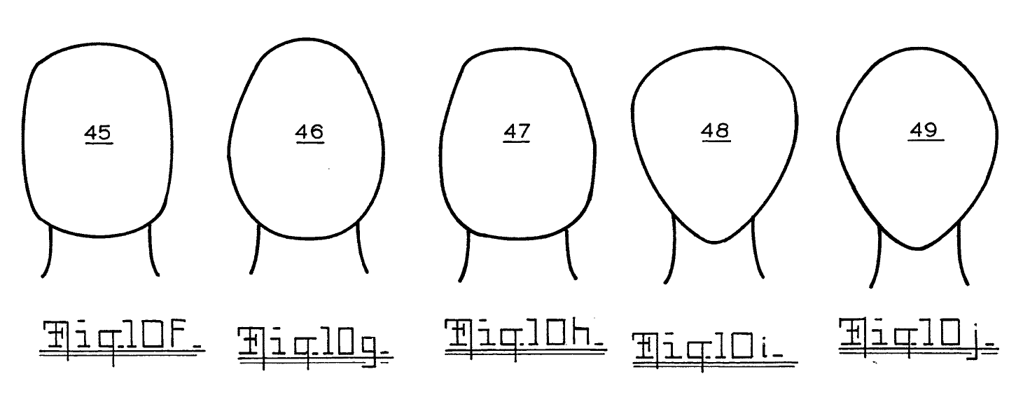

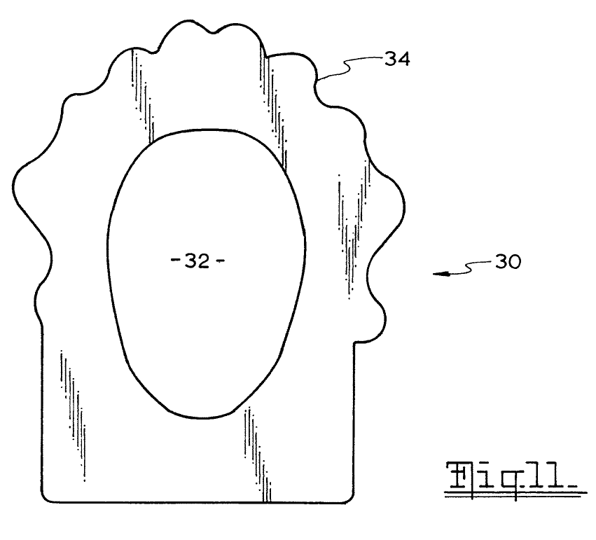

It is generally regarded that there are ten types of facial outline shapes 40-49, as shown in FIGS. 10a-10j. Corresponding to these ten shapes 40-49, a set of ten members 30 is provided, ideally in the form of brightly coloured translucent perspex sheets. As shown in FIG. 11, each member 30 has a central cut-out portion 32 in the shape of a different face outline. For purposes of fun and identity, each member can have its own unique ‘hairstyle’ 34. As an alternative, a flip chart 50 of members 30 can be provided, see FIG. 12.

The different face shapes are as follows:
FS—1—Oval 40,
FS—2—Angular Oval 41,
FS—3—Oblong 42,
FS—4—Rectangle 43,
FS—5—Round 44,
FS—6—Square 45,
FS—7—Soft Pear 46,
FS—8—Angular Pear 47,
FS—9—Heart 48, and
FS—10—Diamond 49.

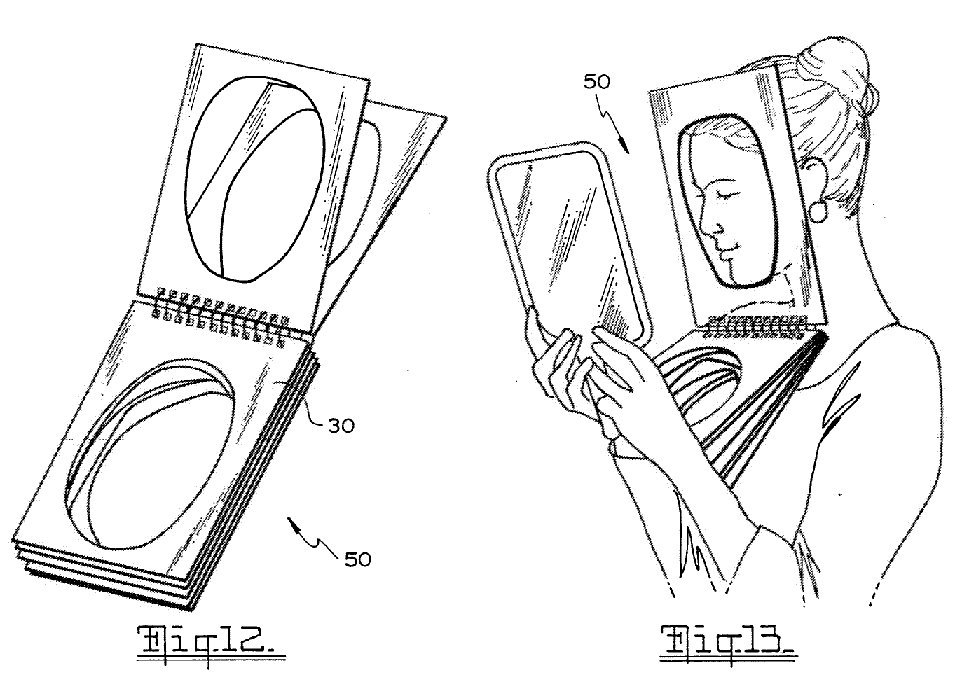

In use the different members 30 are held up to the person's face and the different outline cut outs 32 are compared with the facial shape of the person to find the closest match. Ideally, the process in done in front of a mirror so that the person can see for themselves which shape matches their own, see FIG. 13.

Ideally, each member 30 is provided with a unique code which is used to cross-reference frame shapes which best suit the respective face shape. Options of suitable frame shapes could be provided to the person in the form of actual frames, for the person to try on, or a catalogue or information booklet displaying options of actual frames. In ideal circumstances, a database of frames in stock is provided which can be searched according to the appropriate member code. The classification of frames in stock can be performed as part of a normal retail inventory process.

By using the kit, a person is quickly given an indication of a narrower choice of spectacle frame styles, shapes and colours which would suit the person. In this way, the final selection of frames becomes less tedious to the person and a sales assistant can be more confident about making recommendations.

While the present invention has been described with respect to a specific embodiment and application, it will be appreciated that various modifications and changes could be made without departing from the scope of the invention. Furthermore, it will be appreciated that the present invention is capable of wider application than just for assisting in the selection of spectacle frames. The method and kit can be readily adapted for selecting other adornments, such as jewelry. It is anticipated that the present invention could also be used in the selection of hairstyles or wigs, which for the purposes of the present specification should be taken to fall under the definition of adornments.

1. A method for assisting in the selection of an adornment to be worn by a person, said method comprising:
providing one or more option charts displaying a plurality of options of different possible facial and/or head colour characteristics, each option having an associated collection of suitable adornment colours for the respective colour characteristics;
selecting an option which has colour characteristics which are the nearest match to the person;
indicating to said person, the collection of suitable adornment colours associated with said selected option to allow said person to select a suitable colour for said adornment from said indicated collection;
providing a plurality of different possible facial outline shapes, each facial outline shape having an associated collection of suitable adornment shapes;
selecting one of said facial outline shapes which is the nearest match to the facial outline shape of said person; and
indicating to said person, the collection of suitable adornment shapes associated with said selected facial outline shape to allow said person to select a suitable adornment shape from said indicated collection.

2. The method according to claim 1, wherein said different possible facial and/or head colour characteristics comprise one or more of skin colour, complexion, eye colour and hair colour.

3. The method according to claim 1, wherein said plurality of options of different possible facial and/or head colour characteristics are displayed on said one or more option chart in the form of photographic images of models exhibiting said different possible facial and/or head colour characteristics.

4. The method according to claim 1, wherein said step of indicating the collection of suitable adornment colours associated with said selected option comprises providing a colour chart displaying said collection of suitable adornment colours.

5. The method according to claim 1, wherein each option chart, displaying a plurality of options of different possible facial and/or head colour characteristics, displays said options side by side in a single row along said chart.

6. The method according to claim 4, wherein each option chart, displaying a plurality of options of different possible facial and/or head colour characteristics, displays said options side by side in a single row along said chart.

7. The method according to claim 6, wherein for each option chart, displaying a plurality of options of different possible facial and/or head colour characteristics, a corresponding colour chart is provided displaying each associated collection of suitable adornment colours arranged in a corresponding position on said colour chart to each associated option such that, when the colour chart is placed in alignment with said option chart, each displayed option is aligned with its associated displayed collection of suitable adornment colours.

8. The method according to claim 1, wherein said plurality of different possible facial outline shapes are provided in the form of a plurality of template members, each template member having a cut-out portion in the shape of a possible facial outline shape; wherein said step of selecting one of said facial outline shapes which is the nearest match to the facial outline shape of said person comprises holding up each template member to the face of the person.

9. The method according to claim 1, wherein said adornment is a pair of spectacles.

10. A kit for assisting in the selection of an adornment to be worn by a person, said kit comprising:
one or more option charts displaying a number of options of different possible facial and/or head colour characteristics for comparison with the facial and/or head colour characteristics of said person;
one or more colour charts displaying a corresponding number of collections of suitable adornment colours, each collection of suitable adornment colours being associated with a different option on said one or more option charts; and
a plurality of members, each member providing a different possible facial outline shape for comparison with the facial outline shape of said person, each facial outline shape having an associated collection of suitable adornment shapes.

11. The kit according to claim 10, wherein said different possible facial and/or head colour characteristics comprise one or more of skin colour, complexion, eye colour and hair colour.

12. The kit according to claim 10, wherein said number of options of different possible facial and/or head colour characteristics are displayed on said one or more option charts in the form of photographic images of models exhibiting said different possible facial and/or head colour characteristics.

13. The kit according to claim 10, wherein each option chart displays options side by side in a single row along said chart.

14. The kit according to claim 13, wherein for each option chart a corresponding colour chart is provided displaying each associated collection of suitable adornment colours arranged in a corresponding position on said colour chart to each associated option such that, when the colour chart is placed in alignment with said option chart, each displayed option is aligned with its associated displayed collection of suitable adornment colours.

15. The kit according to claim 10, wherein each member provides a different possible facial outline shape in the form of an appropriately shaped cut-out portion.

16. The kit according to claim 10, wherein said adornment is a pair of spectacles.
